(19) United States
(12) Patent Application Publication
(10) Pub. No.: US 2014/0150488 A1
(43) Pub. Date: Jun. 5, 2014

(54) COMPACT DEHUMIDIFIERS AND ASSOCIATED SYSTEMS AND METHODS

(71) Applicant: DRI-EAZ PRODUCTS, INC., Burlington, WA (US)

(72) Inventors: Richard A. Black, Bellingham, WA (US); Keith Hoffman, Lake Stevens, WA (US); William Bruders, Sedro Woolley, WA (US); Larry White, Mount Vernon, WA (US); Brett Bartholmey, Bellingham, WA (US); Aaron Matthew Kiesser, Mount Vernon, WA (US)

(73) Assignee: DRI-EAZ PRODUCTS, INC., Burlington, WA (US)

(21) Appl. No.: 13/843,279

(22) Filed: Mar. 15, 2013

Related U.S. Application Data
(60) Provisional application No. 61/733,372, filed on Dec. 4, 2012.

(51) Int. Cl. F24F 3/14; B23P 15/26

(52) U.S. Cl. CPC F24F 3/14; B23P 15/26
USPC 62/404; 29/890.035

(57) ABSTRACT

Compact dehumidifiers and associated systems and methods are disclosed. A representative system includes a housing having an airflow entrance, and airflow exit, and a linear flowpath between the entrance and exit. The system further includes a refrigeration cycle having, in sequence along the flowpath, an evaporator, a compressor, a condenser, and an air flow driver. A controller is operatively coupled to the evaporator, compressor, condenser, and airflow driver to operate the refrigeration cycle for removing moisture from an entering airflow.

### CROSS-REFERENCE TO RELATED APPLICATION

The present application claims priority to U.S. Provisional Application No. 61/733,372, filed Dec. 4, 2012 which is incorporated herein by reference. To the extent the foregoing application and/or any other materials incorporated herein by reference conflict with the present disclosure, the present disclosure controls.

### TECHNICAL FIELD

The following disclosure is directed generally to compact dehumidifiers and associated systems and methods, including dehumidifiers and associated systems and methods that produce low-grain performance without pre-cooling.

### BACKGROUND

Dehumidifiers are used for removing moisture from air. A conventional dehumidifier typically directs a flow of air over, across, and/or through several components that together form a refrigeration cycle. The components of the refrigeration cycle cool the airflow below the dew-point temperature so that water vapor in the air is condensed to a liquid phase and removed. Dehumidifiers are useful in many different environments and situations. For example, dehumidifiers are frequently used in residential applications to reduce the level of humidity in the air for health reasons, as humid air can cause unwanted mold or mildew to grow inside homes. Many homeowners operate dehumidifiers to decrease the humidity of the air in their homes for comfort reasons, as extremely humid air can be uncomfortable. Dehumidifiers are also frequently used in commercial or industrial applications, for example, to dry the air in water damage restoration projects. The drier air helps contractors restore buildings or other structures that have been flooded or have suffered other types of water damage.

### BRIEF DESCRIPTION OF THE DRAWINGS

FIGS. 1A and 1B illustrate, respectively, left and right isometric views of a dehumidifier system in accordance with an embodiment of the present disclosure.

FIG. 1C illustrates dehumidifiers stacked in accordance with a particular embodiment of the disclosure.

FIGS. 2A and 2B illustrate, respectively, side and front views of a dehumidifier sized in accordance with an embodiment of the present disclosure.

FIG. 3 is a partially schematic, top isometric illustration of a representative dehumidifier having a portion of the dehumidifier housing removed to illustrate internal components.

FIG. 4 is a partially exploded illustration of a dehumidifier with components positioned for installation in a housing portion in accordance with an embodiment of the present disclosure.

FIG. 5 is a partially schematic side view of representative dehumidifier components installed in a lower portion of a dehumidifier housing in accordance with an embodiment of the present disclosure.

FIG. 6A is a top isometric view of a lower housing portion configured in accordance with an embodiment of the present disclosure.

FIG. 6B is an isometric view of an inverted upper housing portion configured in accordance with an embodiment of the present disclosure.

FIGS. 7A-7C illustrate seals positioned between components of a dehumidifier in accordance with an embodiment of the present disclosure.

FIG. 8 is a partially schematic, top isometric illustration of the interior of a dehumidifier illustrating selected components in accordance with another embodiment of the present disclosure.

FIG. 9 is a partially schematic, cut-away side view of a dehumidifier system configured in accordance with an embodiment of the present disclosure.

FIGS. 10A and 10B illustrate an electrical unit separately (FIG. 10A) and installed in a dehumidifier (FIG. 10B) in accordance with an embodiment of the present disclosure.

FIGS. 11A-11E illustrate a process for installing an electrical unit in a dehumidifier in accordance with an embodiment of the present disclosure.

FIG. 12A illustrates a dehumidifier installed beneath a floor in accordance with an embodiment of the present disclosure.

FIG. 12B illustrates a dehumidifier installed beneath a floor in accordance with another embodiment of the present disclosure.

FIGS. 13A-13C illustrate dehumidifiers having baffles or flow directors configured in accordance with embodiments of the present disclosure.

FIGS. 14A-14C illustrate dehumidifiers having control panels located in different locations in accordance with still further embodiments of the present disclosure.

### DETAILED DESCRIPTION

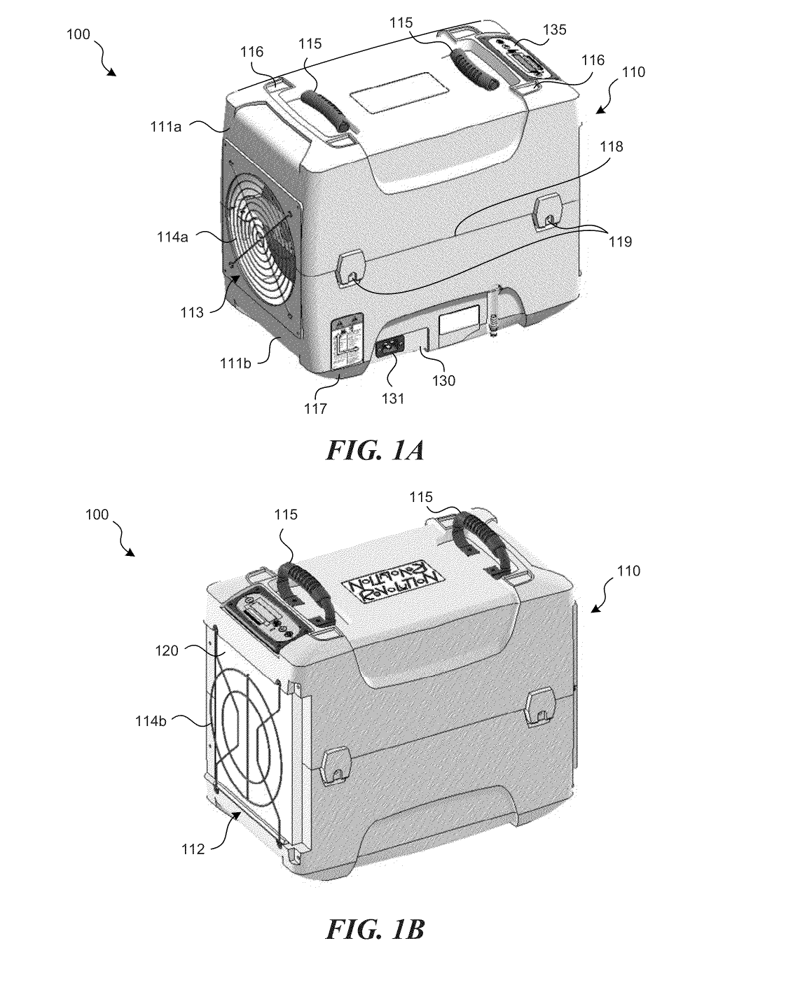

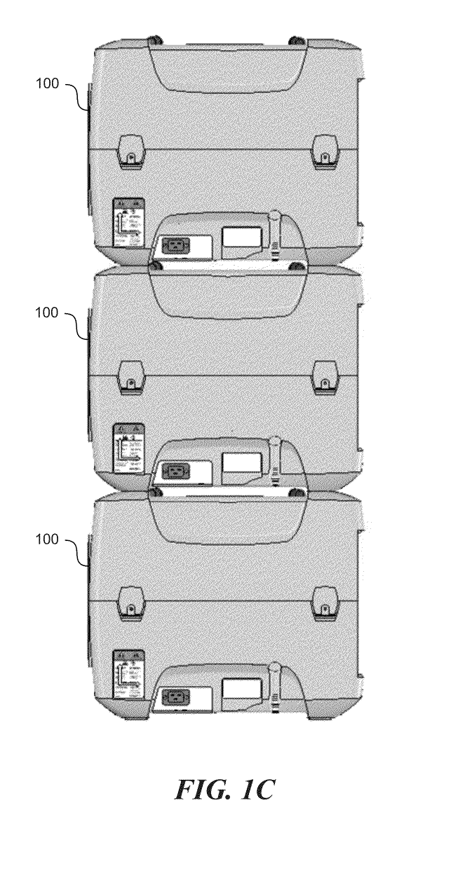

Several embodiments of the present disclosure are described below with reference to representative dehumidifiers that are configured to remove moisture from a continuous flow of air passing through them. Embodiments of dehumidifiers in accordance with the present disclosure can include portable dehumidifiers for (water damage) restoration projects, and dehumidifiers that can be installed in crawl spaces (e.g., under a floor of a house). Specific details are identified in the following description with reference to FIGS. 1A-14C to provide a thorough understanding of various embodiments of the disclosure. Other details describing well-known structures or processes often associated with dehumidifiers are not described below to avoid unnecessarily obscuring aspects of the various embodiments of the disclosure. Although the following disclosure sets forth several embodiments of different aspects of the disclosed technology, other embodiments can have different configurations and/or different components than those described in this section. In addition, further embodiments of the technology may be practiced without several of the details described below, while still other embodiments of the technology may be practiced with additional details and/or features.

FIG. 1A is a partially schematic left side view of a dehumidifier system 100 configured in accordance with an embodiment of the present technology. FIG. 1B is a right side view of the system 100 shown in FIG. 1A. Referring to FIGS. 1A and 1B together, the system 100 can include a housing or enclosure 110 formed from two components, e.g., an upper portion 111a and a lower portion 111b having a clamshell arrangement. The upper and lower portions 111a, 111b can be economically formed using a roto-molding process, and can be joined along a joint line 118. In a particular embodiment, one or more latches 119 and/or bolts or other fasteners are used to join the two portions 111a, 111b to each other, and can allow the system 100 to be opened for maintenance, cleaning, and/or repairs. The housing 110 includes an airflow inlet 112 (visible in FIG. 1B) and an airflow outlet 113 (visible in FIG. 1A). The inlet 112 can include a grill 114b that supports a filter 120. The filter 120 prevents debris from entering the housing 110 where it may harm and/or interfere with the refrigeration cycle components contained therein. The outlet 113 can also include a grill 114a positioned to protect users from inadvertently striking a fan or other air driver located within the housing 110.

The system 100 can include an electrical unit 130 having an electrical terminal (or electrical connector) 131 that receives power (e.g., wall power) from a suitable source. The electrical unit 130 is operatively coupled to a control panel 135 that is used to control the operation of the system 100. The system 100 can further include one or more handles 115 and/or a shoulder strap to facilitate moving the system 100 from one location to another. The system 100 can include one or more feet, pedestals or supports 117 that allow the system to be readily placed on a surface. In particular embodiments, the system 100 can also include recesses 116 in the upper portion 111a that allow multiple systems to be readily stacked one on the other (e.g., the individual support 117 can have a convex surface at least partially matching a corresponding concave surface of the individual recess 116), as is shown in FIG. 1C. This arrangement can allow the multiple systems 100 to be transported and/or stored easily in a compact and stable arrangement.

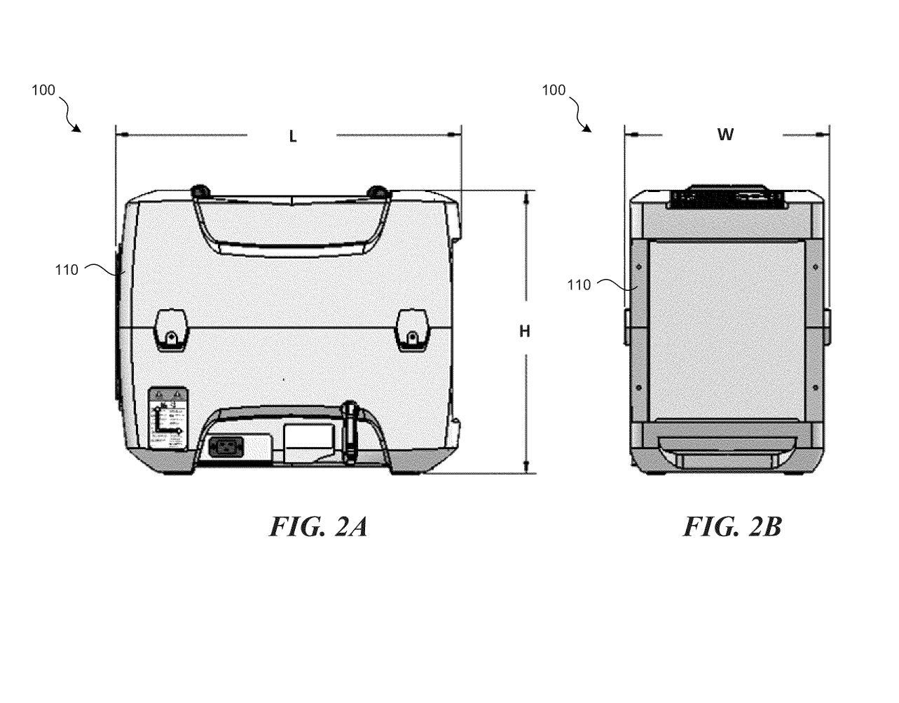

FIG. 2A is a side view of a representative system 100, and FIG. 2B is a front view of the system 100 shown in FIG. 2A. The system 100 can have an overall length L, an overall height H, and an overall width W. In particular embodiments, the system is deliberately designed to be more compact than existing dehumidifiers, while maintaining high low grain performance. For example, the overall length L can be about 22 inches, the overall height H can be about 18 inches, and the overall width W can be about 13 inches. This compact arrangement allows multiple dehumidifiers to be readily carried in small vehicles, and/or allows the dehumidifier to be more portable, e.g., so as to be installed in tight spaces. Such spaces can include crawl spaces beneath the floor of a house or other building for permanent or semi-permanent use, and/or the open living spaces of compact living quarters, such as small apartments or houses. In any of these embodiments, the compact footprint and volume of the system 100 facilitate using the system in a wider variety of environments than are accessible to larger units. In addition, the small volume of the system generally results in a lower weight, which also allows the system to be used in a wider variety of environments than are accessible to heavy systems. For example, a representative system 100 can have a weight of about 65 pounds or less. Several of the features that produce the compact arrangement are described further below.

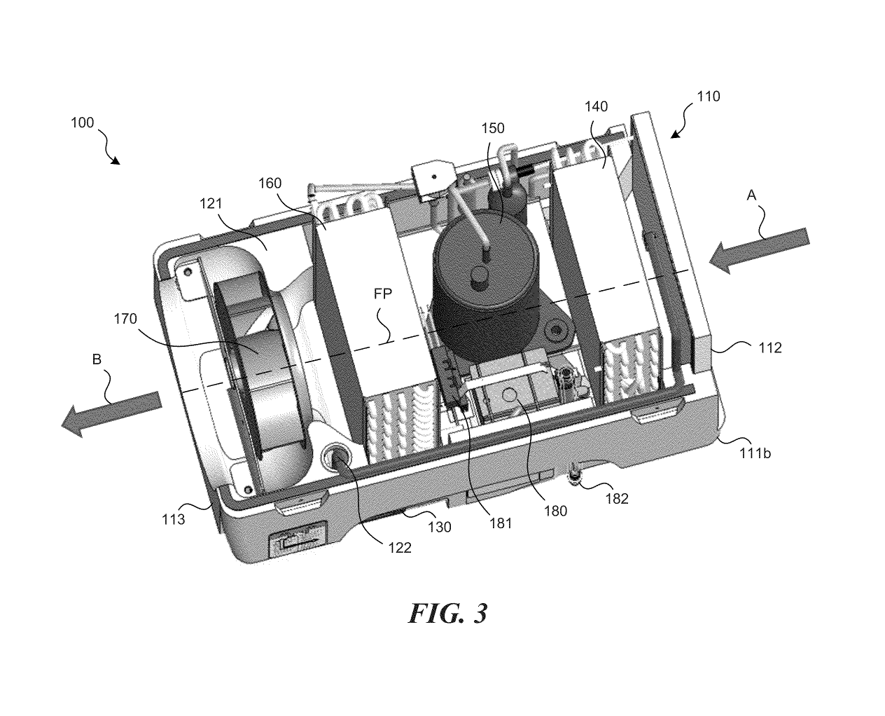

FIG. 3 is a top isometric view of an embodiment of the system 100, with the upper housing portion 111a (FIG. 1A) removed to illustrate components that form the refrigeration cycle. These components can include an evaporator 140, a compressor 150, a condenser 160, and an air driver 170. Each of the foregoing components can be located along a generally linear flowpath FP which is in turn located between the inlet 112 and the outlet 113. Inlet airflow enters the inlet 112 as indicated by arrow A, passes through and/or adjacent to the refrigeration cycle components along the flowpath FP, and exits via the outlet 113, as indicated by arrow B. In some embodiments, the evaporator 140, the condenser 160, and/or the air driver 170 can be detachably coupled to the housing 110 (e.g., the lower portion 111b). This arrangement can improve manufacturability and/or maintenance because individual refrigeration cycle components (or the components all together) can simply be dropped into or pulled out of the lower portion 111b of the housing 110. The compressor (and in some case, only the compressor) is specifically attached to the housing 110, while the other component can rest in the housing 110 and/or be clamped in place when the two portions 111a, 111b are connected to each other.

One feature of the foregoing arrangement is that, by aligning the components along a linear flowpath FP, the overall size of the system 100 can be reduced when compared to existing systems. In particular, the linear flowpath FP does not loop through transverse sections of a heat exchanger block. In addition to reducing system size, this feature can improve system efficiency by reducing energy losses associated with turning fluid flows. This efficiency increase can be particularly important for small, compact systems.

An additional feature includes oversizing the condenser 160 relative to the evaporator 140. By oversizing the condenser 160 relative to the evaporator 140, the system 100 is more robust than conventional systems and can more reliably keep the evaporator 140 operating at or close to the evaporator design temperature.

Still another feature of the arrangement shown in FIG. 3 is that the system 100 can operate without pre-cooling. In particular, the compressor 150 can be cooled by air that has passed through (and has been cooled by) the evaporator 140.

Yet another feature includes an evaporator 140 having multiple coolant circuits. For example, the evaporator 140 can have two coolant circuits. The different circuits can be “tuned” and/or selected based on particular air flow patterns of the evaporator 140.

The foregoing features, individually and/or together, allow the system 100 to operate effectively in dry conditions. Such conditions can include conditions for which the specific humidity is below 40 gpp (grains per pound). A particular condition includes operation at 80° F. and 20% relative humidity corresponding to a specific humidity of approximately 32 gpp. Embodiments of the present technology include systems that successfully withdraw moisture from air in the local environment, even under such conditions. Of course, the system can also extract moisture from air having a specific humidity above the foregoing values, e.g., up to and including completely saturated air. It can also extract moisture from air having a specific humidity of less than 32 gpp, e.g., 20 gpp. This is unlike typical refrigeration-based dehumidifiers (e.g., as opposed to desiccant-based dehumidifiers) which are generally unable to extract moisture from air having a specific humidity of less than 80 gpp.

Other features of the system 100 shown in FIG. 3 include a pump 180 coupled to a float switch 181. The pump 180 is used to remove water (e.g., via a water line 182) extracted from the airflow entering the system 100 by the evaporator 140. The lower portion 111b of the housing 110 can include a molded-in air driver entrance 121 that guides air exiting the condenser 160 into the air driver 170. In a particular embodiment, the air driver 170 includes an impeller or fan, and in other embodiments, can include other suitable components. The lower portion 111b of the housing 110 can also include a wiring pass-through opening 122 through which cables from the electrical unit 130 pass upwardly to the refrigeration cycle components and associated controls.

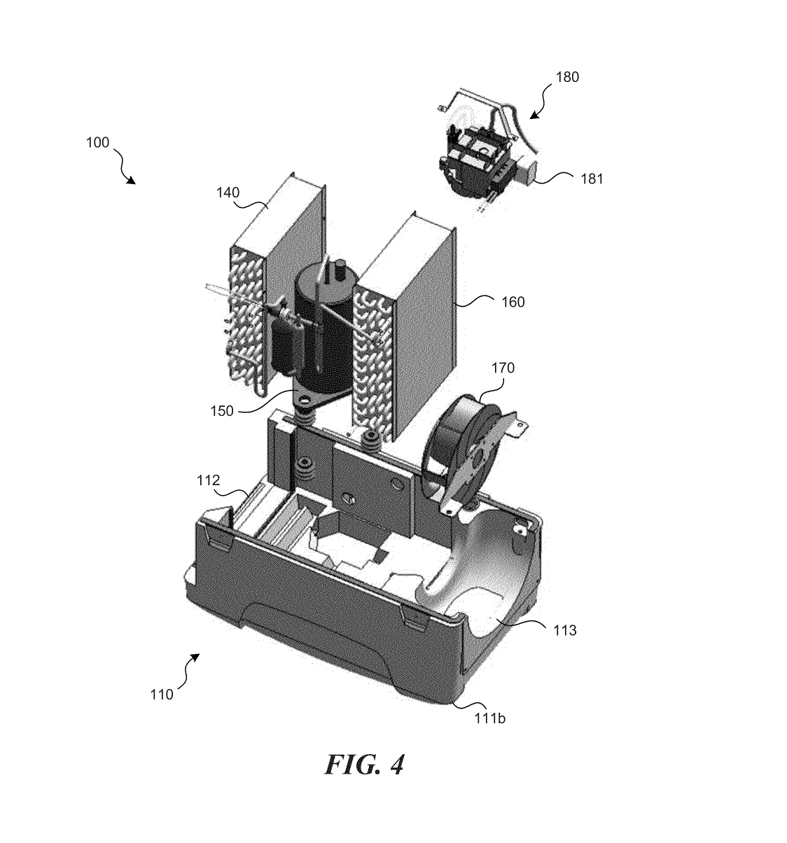

FIG. 4 is a partially exploded illustration of the system 100, with components positioned for installation in accordance with particular embodiments of the present technology. In one embodiment, the lower portion 111b of the housing 110 can operate as a support for all the refrigeration cycle components. Accordingly, the refrigeration cycle components can be simply dropped into place in the lower portion 111b. In particular, the evaporator 140, the compressor 150, and the condenser 160 can be dropped into the lower portion 111b, either separately, or as a unit. The lower portion 111b can similarly receive the pump 180 and float switch 181, and the air driver 170. This arrangement facilitates a process for quickly and easily manufacturing the overall system 100. The two “clamshell”-type housing components can also improve manufacturability by reducing the number of components required to support and enclose the refrigeration cycle elements.

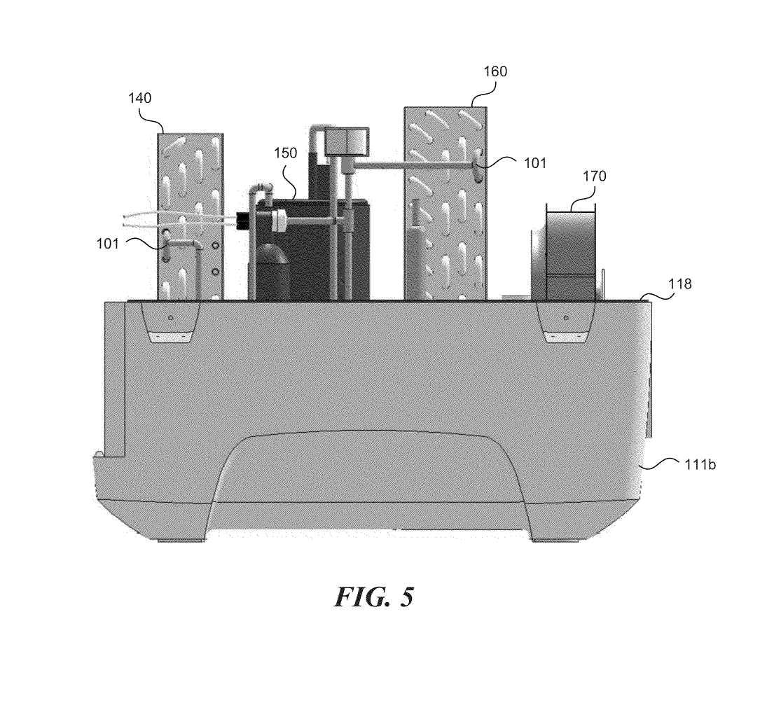

FIG. 5 is a side elevation view of the refrigeration cycle components installed in the lower portion 111b. The lower portion 111b in this embodiment is deliberately sized so as to allow connections between the components to be made easily, even after the components have been placed into the lower portion 111b. For example, the conduits connecting the compressor 150 to the condenser 160 and the evaporator 140 can include connection locations 101 that are deliberately positioned above the joint line 118 between the lower portion 111b and the upper portion 111a (shown in FIG. 1A). The connection locations 101 can be configured for brazing and/or other connection techniques.

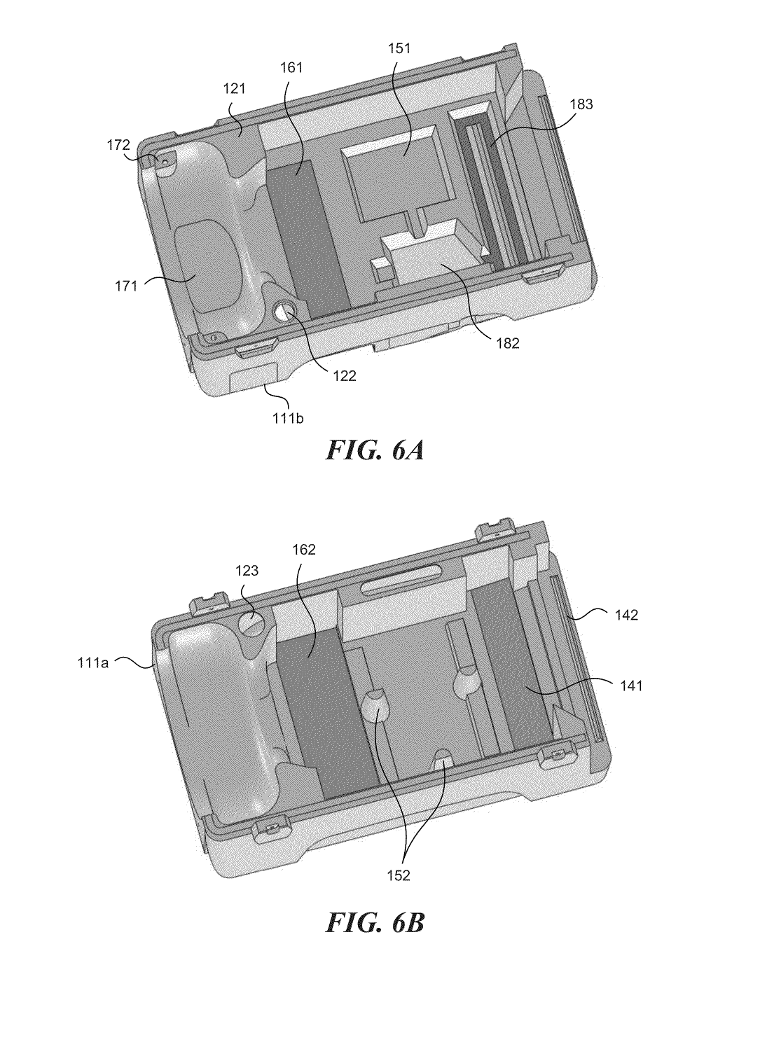

FIG. 6A is a partially schematic, top isometric illustration of the lower portion 111b illustrating features that support the refrigeration cycle components described above with reference to FIG. 5. In particular, the lower portion 111b can include a water collection recess 183 positioned below the site at which the evaporator 140 (FIG. 5) is placed into the lower portion 111b. The water collection recess 183 can communicate fluidly with a pump reservoir 182 that houses the pump 180 and float switch 181 (FIG. 4) and provides a low point from which to evacuate the water collected in the water collection recess 183. For example, when the water collected in the water collection recess 183 reaches a predetermined level, the float switch 181 can actuate the pump 180 to evacuate the collected water. A compressor pad 151 provides a site for supporting the compressor 150 (FIG. 5), and a condenser pad 161 provides a site for supporting the condenser 160 (FIG. 5). An air driver cavity 171 is located downstream of the condenser pad 161 to support the air driver 170 (FIG. 5). Air driver mounts 172 are located to fasten the air driver 170 in place.

FIG. 6B is an isometric view of the upper portion 111a inverted to illustrate features within it. These features can include a filter guide 142 that supports the filter 120 (FIG. 1B), an evaporator support 141 that supports or captures the evaporator 140 (FIG. 5), one or more compressor support studs 152 that support or capture the compressor 150 (FIG. 5), and a condenser support region 162 that supports or captures the condenser 160 (FIG. 5). The upper portion 111a can also include a cable access port 123 for electrical communication between elements of the system 100.

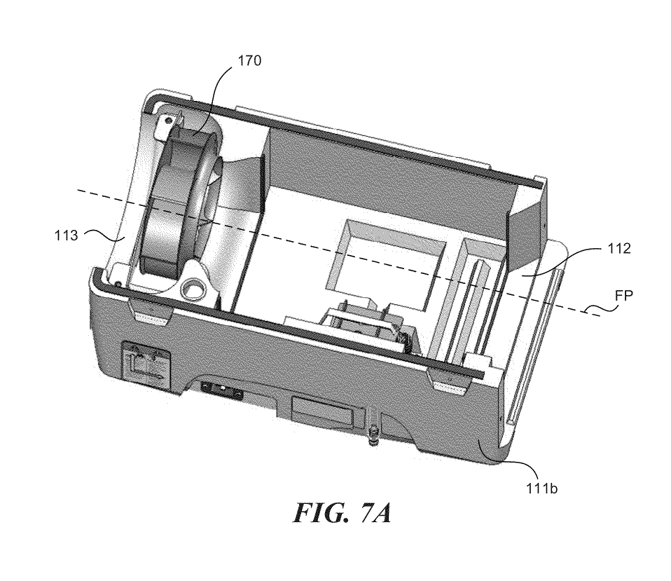

Several of the elements and/or components of the system 100 include seals to prevent airflow from escaping the flowpath FP, shown in FIG. 7A. These seals can include an evaporator inlet gasket 143 (shown in FIG. 7C) that seals the evaporator 140 against the lower housing portion 111b (shown in FIG. 7B) and/or a condenser outlet gasket 163 (shown in FIG. 7B) that seals the outlet of the condenser against the air driver entrance 121. The system 100 can include seals configured in accordance with other arrangements in other embodiments.

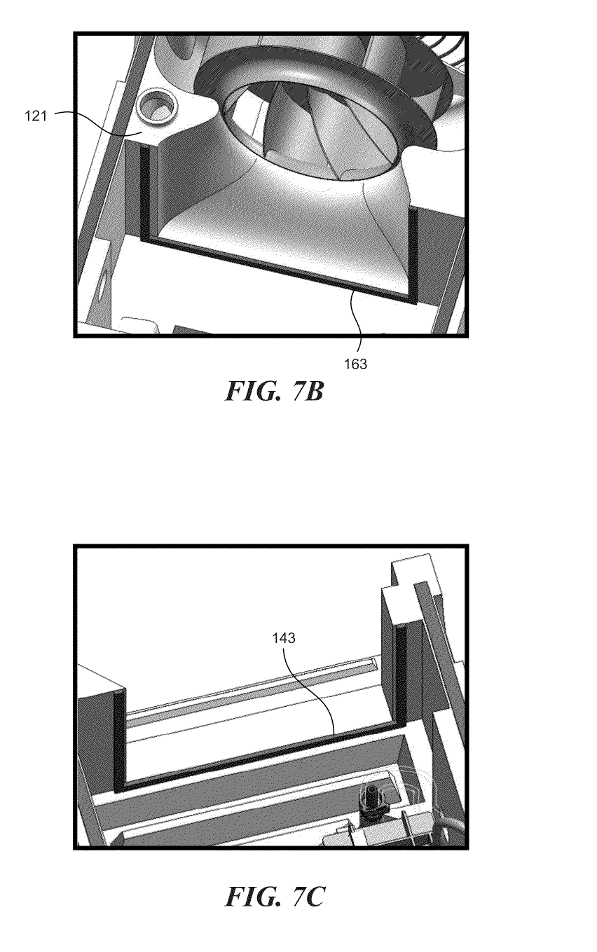

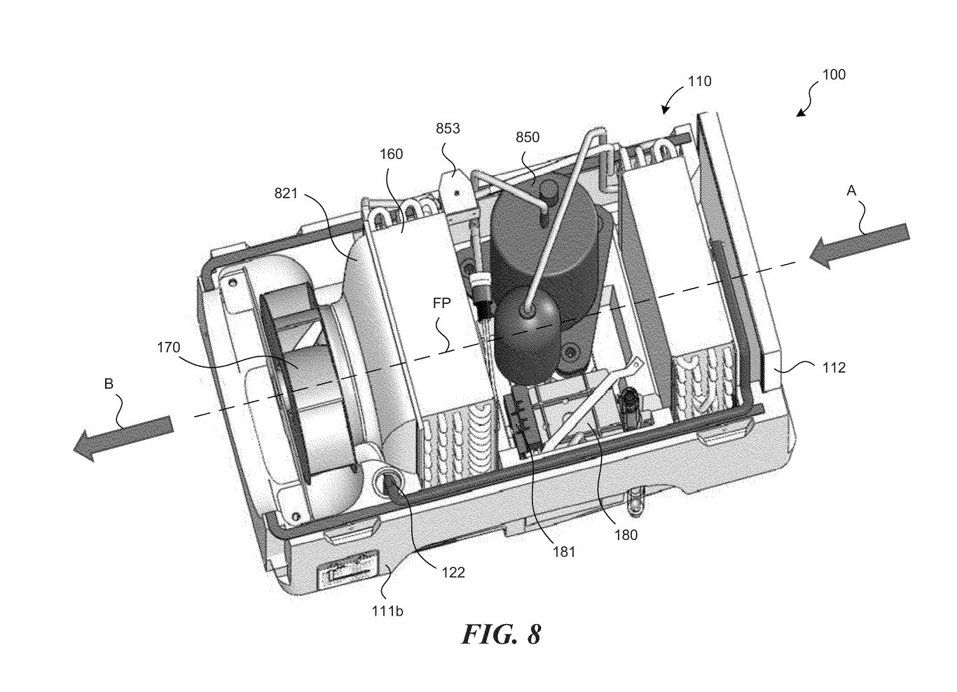

FIG. 8 is a partially schematic, isometric illustration of a system 100 having several components configured in accordance with another embodiment of the disclosed technology. For example, FIG. 8 illustrates a larger compressor 850 coupled to a hot gas bypass valve 853. The hot gas bypass allows some of the warm refrigerant to be diverted to the evaporator 140. This process can speed up the defrost cycle during cool temperature operation. The system 100 can also include an air driver entrance 821 that is not integrally formed with the lower housing portion 111b. Instead, the air driver entrance 821 can be dropped into position between the condenser 160 and the air driver 170 in a manner generally similar to that described above with reference to FIG. 4. In another embodiment, the air driver 170 can be moved to the inlet side of the evaporator 140, resulting in a “pusher” design rather than a “puller” design.

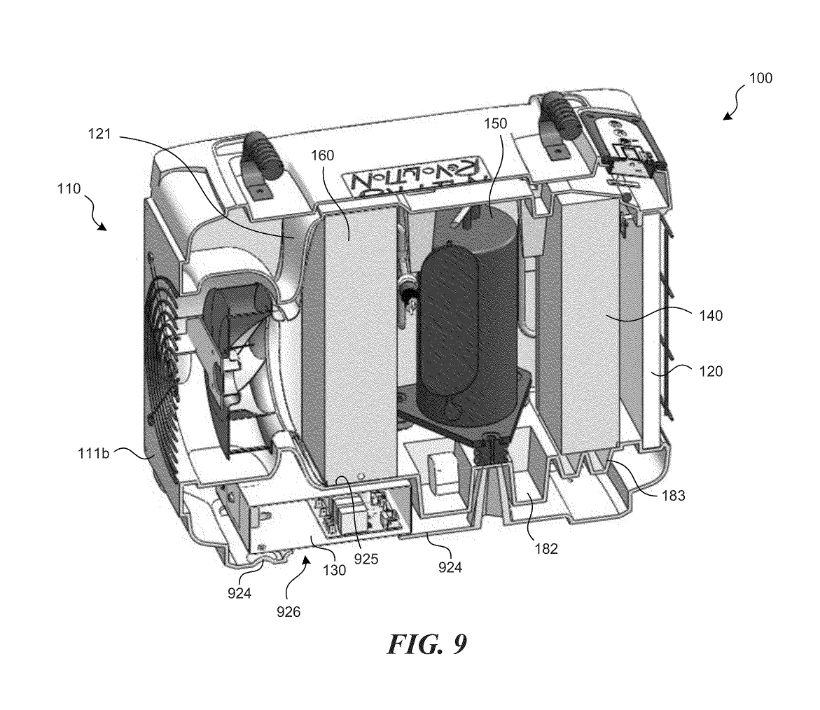

FIG. 9 is a partially schematic, cross-sectional side view of an embodiment of the system 100 illustrating features of the lower portion 111b. In particular, FIG. 9 illustrates an embodiment of the lower portion 111b that includes a double-wall construction, formed by an exterior wall 924 and an interior wall 925. In a particular aspect of this embodiment, the exterior wall 924 and the interior wall 925 can define a slot 926 into which the electrical unit 130 is placed. This arrangement can allow the electrical unit 130 to be easily and securely attached to the housing 110 at a location where it is not exposed to water, and in an orientation that allows it to be readily removed for service, replacement, and/or maintenance, as needed.

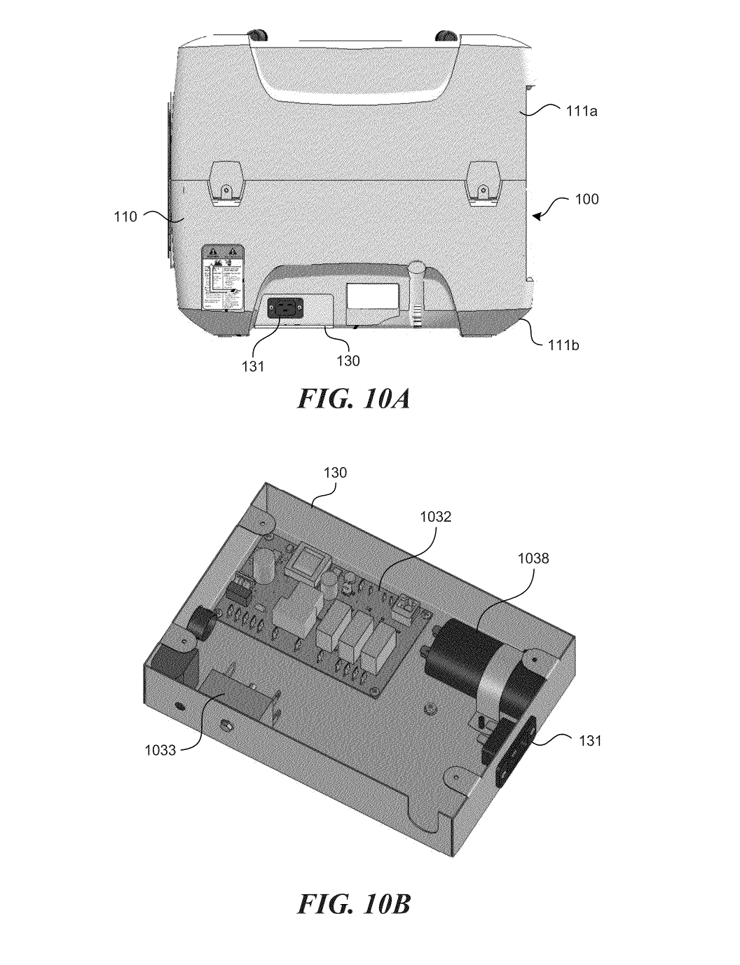

FIG. 10A is a side view of the system 100 illustrating the location of the electrical unit 130. As noted above, the electrical unit 130 is placed outside the interior wall 925 of the housing 110 so as to be isolated from fluid that may be located within the housing 110. At the same time, the electrical connector 131 is readily accessible to the user for coupling the electrical unit 130 to wall power.

FIG. 10B illustrates further details of the electrical unit 130, including the electrical connector 131, a circuit board 1032, a charge capacitor 1038, and a speed controller 1033. These and/or other elements may be housed in the control unit 130.

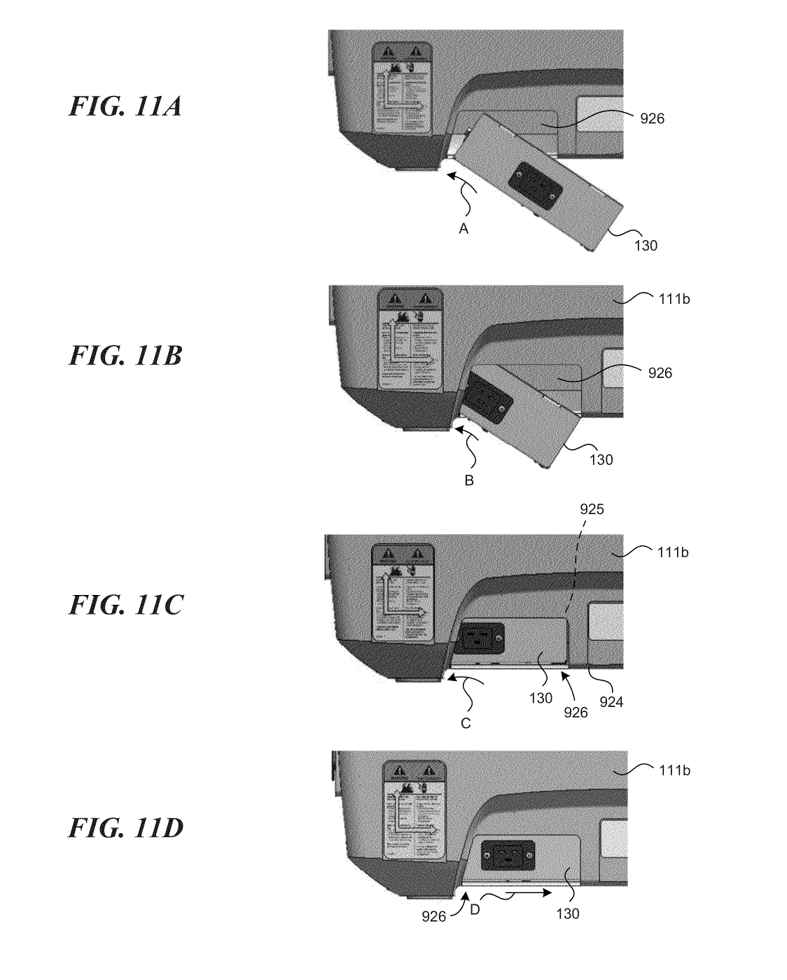

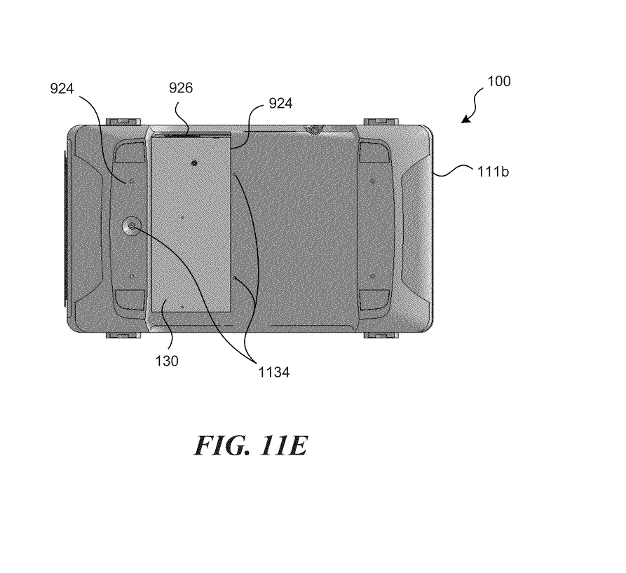

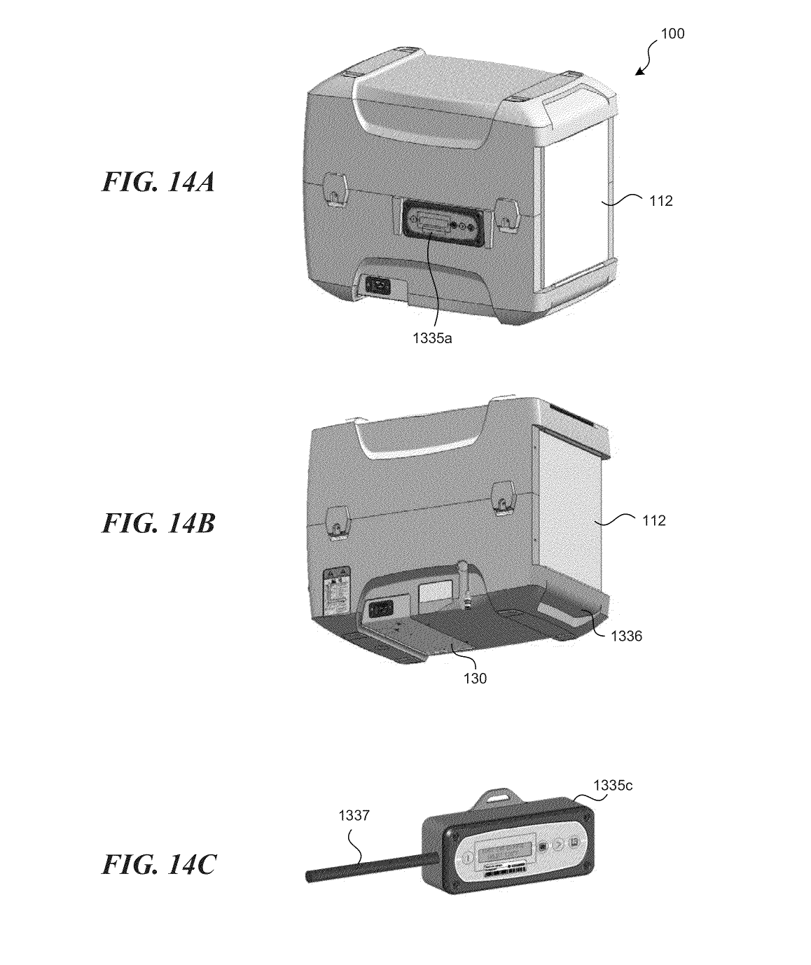

FIGS. 11A-11E illustrate a sequence for installing the electrical unit 130 in the lower housing portion 111b. The electrical unit 130 can be a portion of (or simply supply power to) a controller or a control module of the system 100. The controller can also include a control panel (e.g., the control panel 1335a discussed below and shown in FIG. 14C). As shown in FIG. 11A, the electrical unit 130 is oriented so as to be directed into the slot 926 described above with reference to FIG. 9, as indicated by arrow A. In FIGS. 11B and 11C, the electrical unit 130 is moved further into the slot 926, as indicated by arrows B and C, respectively. In FIG. 11D, the electrical unit 130 is slid from left to right so that it is securely positioned in the slot 926 with opposite ends captured between the exterior wall 924 and the interior wall 925. FIG. 11E is a bottom view of the system 100 illustrating the electrical unit 130 in position within the slot 926. Fasteners 1134 secure the electrical unit 130 to the exterior wall 924.

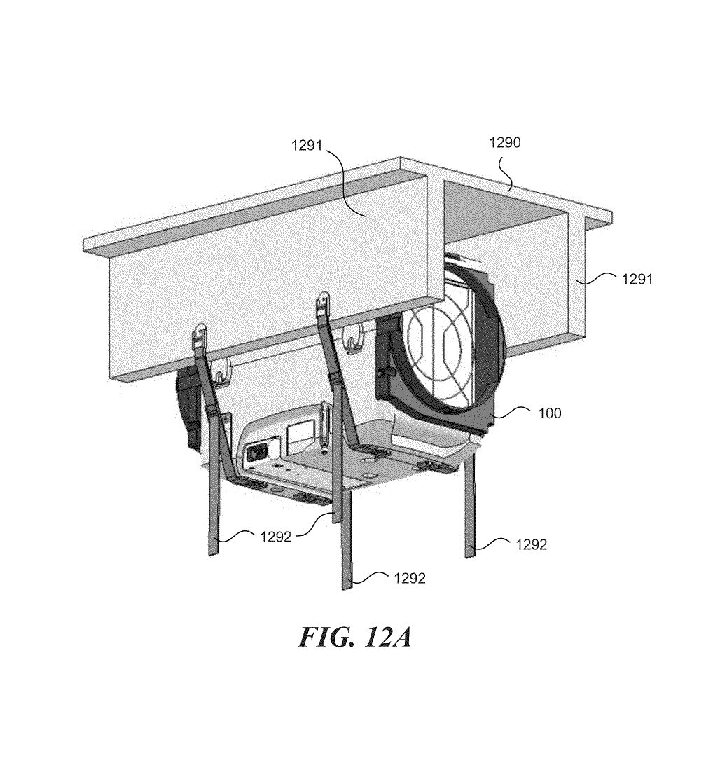

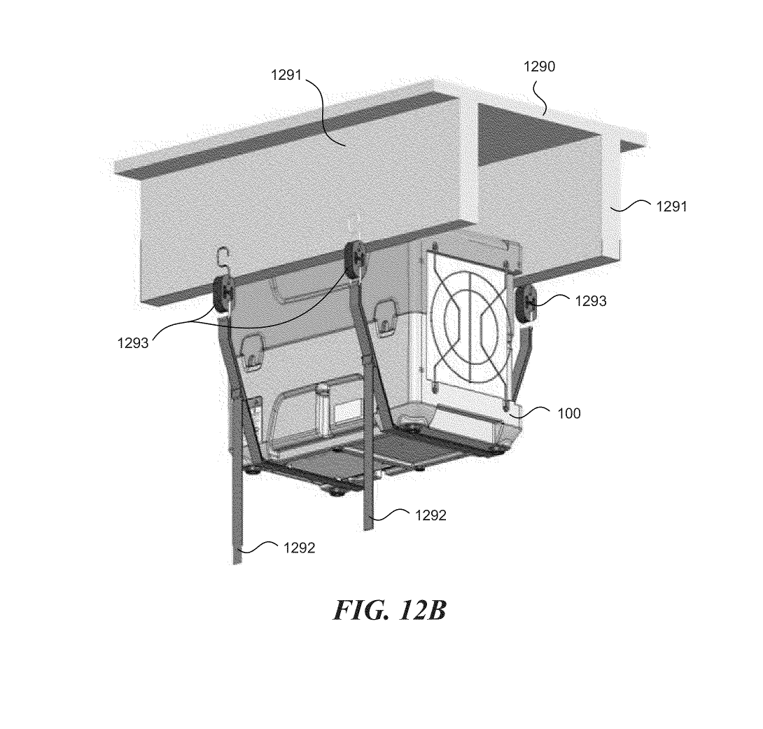

FIG. 12A illustrates a representative system 100 installed beneath a floor 1290 between two floor joists 1291, e.g., in a crawl space. In a particular embodiment, the system 100 is deliberately sized to fit between joists 1291 located at standard intervals. In a further particular embodiment, the system 100 can be installed between the joists 1291 by one or more straps 1292. In the illustrated embodiment, the straps 1292 can be aligned in directions generally perpendicular to an airflow direction of the system 100 (e.g., the generally linear flowpath FP in FIG. 3). By pulling on each of the straps 1292, the installer can lift the system 100 into place between the joists 1291. This arrangement can be simpler than conventional arrangements in which the installer must lie on his or her back and lift the unit into place. This arrangement also allows the installer to independently level each corner of the system 100.

FIG. 12B illustrates another representative system 100 installed beneath the floor 1290 in accordance with another embodiment of the present disclosure. In the illustrated embodiment, the system 100 can include a plurality of dampers 1293 coupled to the straps 1292 and the floor 1290. In some embodiments, the dampers 1293 can reduce vibrations, for example, caused by operation of the system 100.

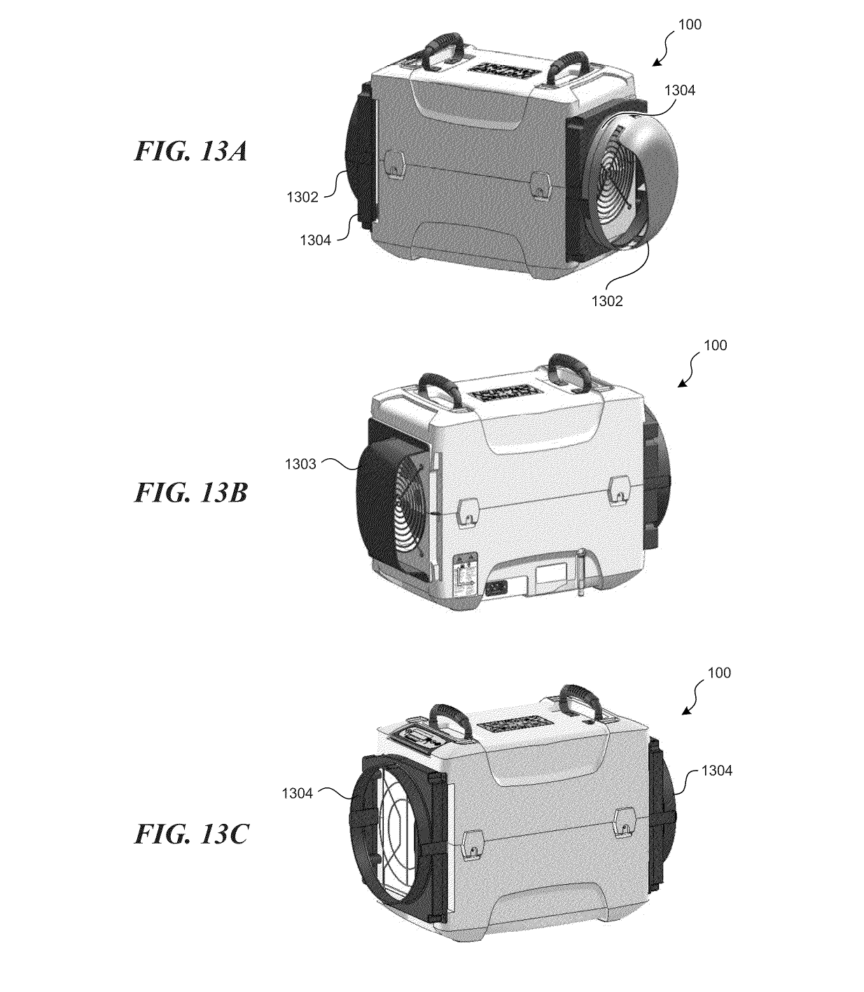

FIGS. 13A-13C illustrate arrangements for directing flow into or out of the system 100 in accordance with particular embodiments of the present technology. In FIG. 13A, multiple duct rings 1304 with optional snap-on swivel baffles 1302 (one at the entrance and one at the exit) can be used to direct flow both into and out of the system 100. FIG. 13B illustrates a fixed, low profile outlet baffle 1303 connected to the exit of the system 100, and FIG. 13C illustrates inlet and outlet duct rings 1304 that can be used alone, or to support the swivel baffle 1302 described above with reference to FIG. 13A.

FIGS. 14A-14C illustrate systems having control panels with different locations in accordance with corresponding different embodiments of the present technology. FIG. 14A illustrates a control panel 1335a positioned in a side surface of the system 100. FIG. 14B illustrates a control panel site 1336 located below the inlet 112 of the system 100. This location may be suitable for housing a control panel when the system 100 is installed beneath a floor surface, e.g., as described above with reference to FIGS. 12A and 12B. FIG. 14C illustrates a control panel 1335c that may be coupled to the system 100 with a tether 1337. Accordingly, a user can easily control the system 100 from a remote location. In other embodiments, the tether 1337 can be replaced with other communication links, e.g., wireless links. The tether 1337 and/or other communication link can allow for full control of the system 100, e.g., in addition to displaying information for monitoring.

The methods disclosed herein include and encompass, in addition to methods of making and using the disclosed devices and systems, methods of instructing others to make and use the disclosed devices and systems. For example, a method in accordance with a particular embodiment includes selecting a compact dehumidifier having a housing smaller than an interval between two neighboring joists below a downwardly-facing floor surface of a floor. The compact dehumidifier has at least one adjustable strap coupled to the housing. The method further includes positioning the compact dehumidifier between the two neighboring joints, coupling the adjustable strap to the floor, and moving the compact dehumidifier upwardly toward the downwardly-facing floor surface by adjusting the adjustable strap. A method in accordance with another embodiment includes instructing such a method. Such instructions can be contained on any suitable computer readable medium. Accordingly, any and all methods of use or manufacture disclosed herein also fully disclose and enable corresponding methods of instructing such methods of use or manufacture.

From the foregoing, it will be appreciated that specific embodiments of the present technology have been described herein for purposes of illustration, but that various modifications may be made without deviating from the technology. For example, the overall system can have compact dimensions, weights, and/or enclosed volumes different than those specifically disclosed herein. While embodiments of the systems were described above in the context of operating at high temperatures and low relative humidities, the systems can also operate effectively at other (e.g., less severe) conditions, e.g., higher or lower temperatures, and/or higher relative humidities. Certain aspects of the technology described in the context of particular embodiments may be combined or eliminated in other embodiments. For example, different embodiments can include various combinations of the gasket arrangements described above, the hot gas bypass valve described above, other types of defrost controls, the compressors described above, and/or the air driver entrances described above. Further, while advantages associated with certain embodiments of the disclosed technology have been described in the context of those embodiments, other embodiments may also exhibit such advantages, and not all embodiments need necessarily exhibit such advantages to fall within the scope of the presently disclosed technology. Accordingly, the present disclosure and associated technology can encompass other embodiments not expressly described or shown herein.

I/We claim:

1. A dehumidifier, comprising:
a portable housing having a first molded portion and a second molded portion positioned above and joined to the first molded portion, at least one of the first and second portions including an airflow inlet, at least one of the first and second portions including an airflow outlet, the housing enclosing a linear flowpath from the airflow inlet to the airflow outlet; and
a refrigeration cycle, comprising:
an evaporator positioned in the housing along the linear flowpath between the airflow entrance and the airflow outlet, the evaporator being carried by the first portion;
a compressor positioned in the housing along the linear flowpath between the evaporator and the airflow outlet, the compressor being carried by the first portion;
a condenser positioned in the housing along the linear flowpath between the compressor and the airflow outlet, the condenser being carried by the first portion and being oversized relative to the evaporator; and
an airflow driver positioned in the housing along the linear flowpath between the airflow entrance and the airflow outlet, the airflow driver being carried by the first portion.

2. The dehumidifier of claim 1 wherein the refrigeration cycle is configured to extract moisture from an entering airflow having a specific humidity of 32 gpp or less.

3. The dehumidifier of claim 1 wherein the first portion and the second portion together define a joint line, and wherein the dehumidifier further comprises a connection location positioned above the joint line.

4. The dehumidifier of claim 1 wherein the first portion includes a water collection recess positioned underneath the evaporator and a reservoir having a low point to evacuate water collected in the housing, and wherein the water collection recess is in fluid connection with the reservoir.

5. The dehumidifier of claim 4 wherein the reservoir is a pump reservoir in fluid communication with a pump.

6. The dehumidifier of claim 1 wherein the evaporator, the condenser, or the airflow driver is detachably coupled to the housing.

7. The dehumidifier of claim 1 further comprising:
an evaporator inlet gasket positioned adjacent to and sealing the linear flowpath at the evaporator; and
a condenser outlet gasket positioned adjacent to and sealing the linear flowpath at the condenser.

8. The dehumidifier of claim 1 wherein the first portion includes an air driver entrance positioned adjacent to the airflow driver to guide the entering airflow into the airflow driver.

9. The dehumidifier of claim 1 wherein the first portion includes a first wiring opening corresponding to a cable access port formed with the second portion.

10. The dehumidifier of claim 1, further comprising:
a support positioned on the second portion and having a convex surface; and
a recess positioned on the first portion and having a concave surface, wherein the concave surface at least partially matches the convex surface.

11. The dehumidifier of claim 1, further comprising:
a duct ring positioned adjacent to the airflow inlet or the airflow outlet;
a swivel baffle coupled to the duct ring.

12. The dehumidifier of claim 1 further comprising:
a filter positioned adjacent to the airflow inlet and supported by a filter guide at the first portion; and
a grill positioned adjacent to the filter and supporting the filter.

13. The dehumidifier of claim 1 further comprising a strap coupled to the housing and positioned to fasten the housing to a floor surface.

14. A system for removing moisture from air, comprising:
a housing having an airflow entrance, an airflow exit and a linear flowpath between the entrance and the exit;
a refrigeration cycle that includes, in sequence along the flowpath, between the entrance and the exit:
an evaporator;
a compressor;
a condenser; and
an airflow driver; and
a controller operatively coupled to the evaporator, the compressor, the condenser and the airflow driver to operate the refrigeration cycle to remove moisture from an entering airflow.

15. The system of claim 14 wherein the entering flow has a specific humidity of 32 gpp or less.

16. The system of claim 14 wherein a portion of the housing has an exterior wall and an interior wall, and wherein the exterior wall and the interior wall together define a slot that accommodates at least a portion of the controller.

17. The system of claim 14 wherein the controller is electrically coupled to an electrical connector, a circuit board, a charge capacity, or a speed controller.

18. The system of claim 14, further comprising:
a strap coupled to the housing and positioned to fasten the housing to a floor surface; and
a damper coupled to the strap and the floor surface.

19. The system of claim 14, further comprising a control panel positioned on a surface of the housing, wherein the control panel is coupled to the controller via a tether.

20. A method of manufacturing a compact dehumidifier, the method comprising:
positioning an evaporator in a first housing portion, the first housing portion having an exterior wall and an interior wall, the exterior wall and the interior wall together defining a slot;
positioning a compressor adjacent to the evaporator in the first housing portion;
positioning a condenser adjacent to the compressor in the first housing portion;
inserting a first end of a controller into the slot;
rotating and moving the controller to position a second end, opposite to the first end, into the slot;
horizontally sliding the controller to securely attach the controller to the first housing portion;
operatively coupling the controller to the evaporator, the compressor, and the condenser;
fastening the first housing portion to a second housing portion to form an airflow inlet and an airflow outlet;
wherein the first housing portion and the second housing portion enclose a linear flowpath passing through the airflow inlet, the evaporator, the compressor, the condenser, and the airflow outlet.

21. The method of claim 20, further comprising forming at least one of the first housing portion and the second housing portion by a roto-molding process.

22. The method of claim 20, further comprising fastening the first housing portion below a floor surface via a strap coupled to the housing.

23. The method of claim 20, further comprising coupling the compressor to a hot gas bypass valve to divert at least some of a refrigerant to the evaporator.

24. The method of claim 20, further comprising sizing the first housing portion and the second housing portion to fit between two floor joists in a crawl space.

25. The method of claim 20, further comprising:
sizing the condenser relative to the evaporator; and
sizing the evaporator, the compressor, or the condenser to remove moisture from an entering airflow having a specific humidity of 32 gpp or less.

26. A method of positioning a dehumidifier relative to a floor, the floor having a downwardly-facing floor surface and floor joints extending below the downwardly-facing floor surface, the method comprising:
selecting a compact dehumidifier having a housing smaller than an interval between two neighboring joists below the downwardly-facing floor surface, the compact dehumidifier having at least one adjustable strap coupled to the housing;
positioning the compact dehumidifier between the two neighboring joints;
coupling the adjustable strap to the floor; and
moving the compact dehumidifier upwardly toward the downwardly-facing floor surface by adjusting the adjustable strap.

27. The method of claim 26 wherein coupling the adjustable strap to the floor includes coupling the adjustable strap to at least one of the floor joints.

28. The method of claim 26 wherein coupling the adjustable strap to the floor includes aligning the adjustable strap in a direction generally perpendicular to an entering airflow direction of the compact dehumidifier.

29. The method of claim 26 wherein the adjustable strap is one of two adjustable straps, and wherein adjusting the adjustable strap includes adjusting both adjustable straps.
